(19) United States
(12) Patent Application Publication
(10) Pub. No.: US 2018/0151913 A1
(43) Pub. Date: May 31, 2018

(54) SPECIFIC LIQUID CATHODE BATTERY

(71) Applicant: COMMISSARIAT À L'ÉNERGIE ATOMIQUE ET AUX ÉNERGIES ALTERNATIVES, Paris (FR)

(72) Inventors: Benoît Chavillon, Grenoble (FR); Lionel Blanc, Grenoble (FR); Eric Mayousse, Grenbole (FR); Rémi Vincent, Grenoble (FR)

(21) Appl. No.: 15/823,198

(22) Filed: Nov. 27, 2017

(30) Foreign Application Priority Data
Nov. 28, 2016 (FR) 16 61585

(51) Int. Cl. H01M 10/0563; H01M 4/583; H01M 4/40; H01M 4/36

(52) U.S. Cl. CPC H01M 10/0563; H01M 4/368; H01M 4/40; H01M 4/583

(57) ABSTRACT

The invention relates to a liquid cathode battery which comprises: an anode made of calcium; an electrolyte comprising a sulphur-containing and/or phosphorous-containing oxidising solvent and at least one salt; a cathode comprising, as the active material, a compound which is identical to the above-mentioned oxidising solvent, and which comprises a carbon-containing matrix; characterised in that the carbon-containing matrix is a self-supporting matrix which comprises interlaced carbon fibres and which has a porosity of at least 92% and a specific surface area less than 5 m²/g.

This application claims priority from French Patent Application No. 16 61585 filed on Nov. 28, 2016. The content of this application is incorporated herein by reference in its entirety.

### TECHNICAL FIELD

The present invention relates to a specific liquid cathode battery and more precisely to a battery with a liquid cathode and calcium anode which has a specific cathode matrix which makes it possible to use these batteries at temperatures above 150° C. without causing safety problems and which can also supply a voltage from ambient temperatures.

The present invention may find applications in all domains which require the production of electrical energy in contexts where the temperature is particularly high. Such is the case in oil production applications such as drilling or monitoring of wells in production, or in geothermal applications.

As stated above, the batteries of the invention rely on liquid cathode battery technology. In other words, this means that they rely on the distinctive feature that the active compound used at the cathode also fulfils the role of the electrolyte solvent; one of the leading models for this type of battery being the lithium-thionyl chloride battery.

Thus such a system conventionally comprises the following elements:
a negative electrode (or anode) made of metallic lithium, where oxidation of the lithium occurs in accordance with the following reaction:

Li→Li⁺+e⁻
a positive electrode (or cathode) which generally comprises a matrix that can trap the liquid active compound, in this case thionyl chloride, which is reduced in accordance with the following reaction:

2SOCl₂+4e⁻→S+SO₂+4Cl⁻
an electrolyte arranged between said negative electrode and said positive electrode, said electrolyte comprising as a solvent thionyl chloride, salts and possibly one or more additives,
where the negative electrode and the positive electrode are connected to an external circuit, which receives the electrical current produced via the above mentioned electrodes.

Combining the electrochemical reaction at the positive electrode and the electrochemical reaction at the negative electrode, the overall reaction (so-called discharge) can be schematically represented by the following equation:

4Li+2SOCl₂→S+SO₂(gas)+4LiCl(precipitate)
where the reaction products are thus sulphur, which is partially soluble in the electrolyte, SO₂ gas, which dissolves in the electrolyte and a lithium chloride salt LiCl, which precipitates and forms a continuous network in the constituent carbon-containing matrix of the positive electrode. Since lithium chloride is a crystalline material it gradually reorganises within the matrix to occupy the latter's empty space, so that the matrix thus constitutes a zone for recovery of the reaction products.

The carbon-containing matrix may take one of the following forms:
a matrix resulting from a compressed powder, for example, a graphite powder, and which exhibits a large specific surface area, as defined in FR 2 166 015;
a carbon-containing matrix, made for example of acetylene black, which comprises a dispersion of copper particles, where said carbon-containing matrix results from the aggregation of powders, as described in FR 2 402 307;
a carbon-containing matrix comprised of a carbon aerogel with a large specific surface area, as described in FR 2 872 347.

Although from the point of view of their electrochemical characteristics Li/SOCl₂ batteries offer a certain number of advantages (for example, a thermodynamic voltage of 3.64 V per cell based on the variation in free enthalpy due to the above-mentioned overall discharge reaction; a high theoretical energy per unit mass of 1470 Wh/kg (of the order of 5273 kJ/kg); a low self-discharge effect (evaluated as being 1% loss of capacity per year at a temperature of 20° C.); an operating temperature ranging from −60° C. (limitation set by the electrolyte) to 180° C. (limitation set by the metallic lithium); a low internal pressure, due to the fact that the gaseous reaction products such as SO₂ are partially soluble in the electrolyte), the system also exhibits a number of drawbacks, due in particular to the reactivity of the metallic lithium with humidity in the air or water, to form hydrogen and lithium hydroxide LiOH with the production of heat. Furthermore, a passivation layer is formed at the surface of the lithium (where this layer comprises LiCl), which may cause a voltage drop when there is a current demand.

Finally, as suggested above, the use of this system is theoretically limited to a temperature of 180° C., the melting point of lithium, beyond which short-circuiting occurs which causes thermal runaway and over-pressurisation of the battery, which could lead to it being destroyed.

Thus the use of these batteries at temperatures above 180° C. is not possible because of fusion of the lithium. In addition, the use of batteries with lithium anodes poses safety problems, which occur during their production, transportation, their use and even during recycling.

In order to overcome these drawbacks, the use of a material based on an alloy of lithium with a second metal, and which exhibits a melting point greater than that of metallic lithium alone, has been proposed for a constituent material of the negative electrode. One alloy of this type is an alloy of lithium and magnesium, as described in particular in U.S. Pat. No. 5,705,293, and more specifically alloys which comprise a proportion of magnesium of 30%, which opens up access to operating temperatures of 200-220° C. In effect, the introduction of magnesium in these proportions results in a movement towards higher fusion temperature values, as shown by the Li/Mg phase diagram.

However, given the high internal resistance of these batteries containing such an alloy at the negative electrode, they must be conditioned before use, and these conditioning operations may prove to be restrictive for the user. On the other hand, these batteries may also exhibit safety problems in the event of the anode fusion temperature being exceeded.

Alternatively, batteries that are safer than lithium batteries have been proposed, where these batteries operate with an anode which is not lithium in this case but calcium, and a thionyl chloride-based cathode, with this type of battery being known as a Ca/Thionyl chloride battery.

This type of battery is conventionally made up of the following elements:
a negative electrode (or anode) made of metallic calcium, where oxidation of the calcium occurs in accordance with the following reaction:

Ca→Ca²⁺+2e⁻
a positive electrode (or cathode) which also comprises a matrix that can trap the liquid active compound, in this case thionyl chloride, which is reduced in accordance with the following reaction:

2SOCl₂+4e⁻→S+SO₂+4Cl⁻
an electrolyte arranged between said negative electrode and said positive electrode,
where the overall reaction (so-called discharge) is schematically represented by the following equation:

2Ca+2SOCl₂→2CaCl₂+SO₂+S

The sulphur and the sulphur dioxide are fully or partially soluble in the electrolyte, whereas the calcium chloride CaCl₂ will also precipitate in the matrix, with, however, a different behaviour from that of the lithium chloride LiCl.

In effect, due to the fact that a calcium atom is 180 pm in size (compared with 145 pm for lithium) and that during reaction with chlorine a calcium atom bonds to two chlorine atoms instead of one as a lithium atom does, the molecules of calcium chloride CaCl₂ have a larger volume than lithium chloride molecules. Furthermore, calcium chloride CaCl₂ is an amorphous solid, unlike lithium chloride LiCl, which is crystalline.

Thus during the deposition of the calcium chloride on the matrix, there will be no reorganisation of the latter within the matrix, due to its amorphous and non-electron-conductive character. Furthermore, due to its greater volume it may cause:
deposition only on the surface of the matrix (and not in its pores), which can result in a high resistance to the battery discharge reaction and eventually cause it to fail;
or even if deposition occurs in the pores of the matrix, blockage of the latter may occur, which can prevent circulation of the catholyte or even cause part of the catholyte to become trapped within the matrix, thus rendering it unavailable for subsequent reaction.

On the other hand, the calcium can enable operations at higher temperatures than with lithium, with these higher temperatures exacerbating the above mentioned effects. Thus the yield of a matrix which operates correctly at ambient temperature could be greatly reduced at the high temperatures that are feasible with calcium, since it no longer has a network of pores of sufficient entry diameter or volume to receive the CaCl2 molecules produced by the battery reactions.

In the light of the existing situation the authors of the present invention set themselves the objective of establishing a new type of liquid cathode and calcium anode battery, wherein the drawbacks associated with the problems caused in the matrix by the calcium chloride are overcome, in particular by proposing a specific matrix structure.

### DESCRIPTION OF THE INVENTION

Thus the invention relates to a liquid cathode battery which comprises:
an anode made of calcium;
an electrolyte comprising a sulphur-containing and/or phosphorous-containing oxidising solvent and at least one salt;
a cathode comprising, as the active material, a compound which is identical to the above mentioned oxidising solvent, and which comprises a carbon-containing matrix;
characterised in that the carbon-containing matrix is a self-supporting matrix which comprises interlaced carbon fibres, which has a porosity of at least 90% and a specific surface area equal to or less than 5 m²/g.

Before going into further detail in the description of the invention, the following definitions will be given.

The term cathode conventionally refers, above and below, to the electrode where a reduction reaction occurs, in this present case the reduction of the liquid cathode, when the battery is producing current, that is when it is in a discharge process. The cathode may also be referred to as the positive electrode.

The term anode conventionally refers, above and below, to the electrode where an oxidation reaction occurs, when the battery is producing current, that is when it is in a discharge process. The anode may also be referred to as the negative electrode.

The term active material conventionally refers, above and below, to the material that is directly involved in the reduction reaction occurring at the cathode.

The term self-supporting matrix refers to a matrix which supports itself, in other words, which does not rest on a support such as a metallic grid or strip, as is conventionally the case for carbon-containing matrices used as cathodes which use an active liquid or gaseous material, in order to ensure electrical conduction or act as a current collector and ensure the mechanical strength of the electrode. The matrix of the invention therefore carries out electrical conduction itself and acts as its own mechanical support. In other words, the cathode is therefore devoid of any current collector support other than the self-supporting carbon-containing matrix. In the event of impact or vibrations, there is therefore less chance of short-circuiting occurring, where the short circuits are associated in conventional instances with the deterioration of the interface between the support and the carbon-containing material deposited on the support.

As indicated above, the cathode of batteries which are in accordance with the invention comprise, as the active material, a compound identical to the above mentioned oxidising solvent and a specific carbon-containing matrix which receives said active material and also recovers the battery reaction products such as CaCl₂.

This carbon-containing matrix comprises interlaced carbon fibres, and more specifically is primarily or even exclusively comprised of interlaced carbon fibres. These carbon fibres may advantageously have a length of less than 20 mm and a diameter of less than 15 μm. Specifically, the carbon-containing matrix may take the form of a web of carbon fibres.

Moreover, the carbon-containing matrix has a porosity that is equal to at least 90%, preferably equal to or greater than 92%, for example from 92% to 98% or greater than 95%, and exhibits a specific surface area of less than or equal to 5 m²/g, for example from 0.5 to 5 m²/g, or less than 1 m²/g.

Specifically the porosity corresponds to the volume of the voids in the matrix relative to its total volume. In order to measure this, the matrix, whose quantity and geometric characteristics (length, width and depth) are known, is placed in a known initial volume of electrolyte. Measurements are then made of the difference between the volume of electrolyte after immersion of the matrix and the initial electrolyte volume, where this difference corresponds to the void volume of the matrix. The porosity is deduced from this using the ratio of the void volume to the total volume of the matrix.

It should be pointed out that the specific surface area is measured using the BET method, implemented using Micromeritics Tristar II-Surface Area and Porosity apparatus, with this method being described in the Journal of the American Chemical Society, p. 309 (60), 1938.

By combining a high degree of porosity with a low specific surface area, it is thus possible to overcome the above-mentioned drawbacks, namely the CaCl₂ deposition that occurs at the surface of the matrix and in the pores, which can result in the latter becoming blocked. Both these associated properties also allow discharge to be achieved at ambient temperature without voltage falling below 1.5V and allow optimised operation with very good energy densities per gram of cathode used to be obtained.

Finally, the carbon-containing matrix also meets the requirements for one or more of the following characteristics:
a mass per unit surface area less than or equal to 20 g/m²;
when the matrix takes the form of a plate, its thickness is less than 1 mm, preferably less than 0.5 mm;
the carbon-containing matrix is devoid of binder, such as polymer binder like polytetrafluoroethylene used to ensure mechanic strength.

As regards the mass per unit surface area, this is determined by measuring the mass of the matrix, with the mass value being divided by the surface area in m² of said matrix. Because this mass per unit surface area is, advantageously, less than or equal to 20 g/m², this results in a gain in mass of the matrix and therefore of the electrochemical system wherein said matrix is introduced, and consequently an increase in the energy density per unit mass of said system.

Moreover, to collect current the matrix may be equipped with one or more conductive metal tabs (made for example of nickel) fixed simply using welding.

As for the anode, it is a calcium anode (that is, an anode made entirely of calcium). Calcium has the advantage of having a high melting point (of the order of 842° C.). Moreover, the calcium has a capacity per unit volume of 2.06 Ah/cm³ equal to that of lithium. This means that for an equal volume, the same capacity in calcium can be introduced into the battery.

As mentioned above, the electrolyte comprises a sulphur-containing and/or phosphorous-containing oxidising solvent and at least one salt, with this sulphur-containing and/or phosphorous-containing solvent also constituting the active material of the cathode.

More specifically, the oxidising solvent may be:
a sulphur-containing solvent, comprising one or more chlorine atoms, such as a solvent chosen from thionyl chloride (SOCl₂), sulphuryl chloride (SO₂Cl₂), disulphur dichloride (S₂Cl₂), sulphur dichloride (SCl₂);
a non-chlorinated sulphur-containing solvent, such as sulphur dioxide (SO₂); or
a phosphorous-containing and possibly sulphur-containing solvent comprising one or more chlorine atoms, such as phosphoryl trichloride (POCl₃), thiophosphoryl trichloride (PSCl₃).

Preferably the oxidising solvent is thionyl chloride (SOCl₂).

The salt present in the electrolyte may be the result of the reaction of a Lewis acid with a Lewis base, where this reaction can take place ex situ, that is before the introduction into the battery or in situ, that is within the battery, when the Lewis acid and the corresponding Lewis base are introduced into the battery.

More specifically the salt can be created by the reaction:
of a Lewis base with the formula A¹X₂, wherein X represents a halogen atom, such as a chlorine atom, a bromine atom, a fluorine atom, an iodine atom, and A¹ represents a divalent element, such as an alkaline earth element like Ca and Sr, with formula A²X, wherein X is such as defined above and A² represents a monovalent element, such as an alkali metal element like Na, Li or an ammonium group NH₄⁺, with formula A³X₃, wherein X is as defined above and A³ represents a trivalent element such as Ba; and
of a Lewis acid chosen from an aluminium halide AlX₃, a gallium halide GaX₃, a boron halide BX₃, an indium halide InX₃, a vanadium halide VX₃, a silicon halide SiX₄, a niobium halide NbX₅, a tantalum halide TaX₅, a tungsten halide WX₅, a bismuth halide BiX₃, borohydrides, chloroborates and mixtures of these, where X represents, as above, a halogen atom such as a bromine atom, a chlorine atom, a fluorine atom and an iodine atom.

The Lewis acid is, preferably, (AlCl₃) or (GaCl₃) and the Lewis base is SrCl₂, in particular when the oxidising solvent used is thionyl chloride.

Apart from the presence of a solvent and of a salt as defined above, the electrolyte may include one or more additives chosen, for example, in order to limit the self-discharge of batteries and corrosion during discharge.

This and these additives may be chosen from hydrofluoric acid HF, SO₂, salts such as GaCl₃, BiCl₃, BCl₃, GaCl₃, InCl₃, VCl₃, SiCl₄, NbCl₅, TaCl₅, PCl₅ and WCl₆.

This and these additives may be present at a concentration ranging from 0 to 50% of the concentration of the salt.

The batteries of the invention may be developed in accordance with various technologies, and in particular in accordance with two cylindrical battery technologies, which are so-called concentric electrode structure batteries and so-called spiral electrode structure batteries, where these batteries may be in different formats (such as AAA, AA, C, D or DD formats).

These batteries are generally used for “energy” type applications, in which the currents are rather low. The surface area of the electrodes and primarily that of the anode is less, which limits corrosion on discharge.

For so-called spiral electrode structure batteries, these conventionally comprise two flat rectangular electrodes whose width must be compatible with the height of the jacket and which have a length that is configured such that once wound upon themselves, they form a cylinder whose diameter allows it to be introduced into the jacket intended to receive these electrodes.

As stated above, the batteries of the invention find applications in all domains which require production of electrical energy, in contexts where the temperature is high (in particular temperatures above 200° C.), as is the case in particular in oil prospecting and extraction, or in drillings intended for use in geothermal applications. In these fields the batteries of the invention may thus serve as the electrical supply for measurement systems, which already possess electronic components which allow operation at such temperatures.

The invention will now be described with reference to the specific embodiments defined below and with reference to the appended figures.

### BRIEF DESCRIPTION OF THE FIGURES

FIG. 1 is a discharge curve showing the change in the battery voltage U (in mV) as a function of the discharged capacity C (in mAh) at constant current (5 mA) and at 165° C. for the batteries exemplified in example 1.

FIG. 2 is a discharge curve showing the change in the battery voltage U (in mV) as a function of the discharged capacity C (in mAh) at constant current (7 mA) and at 165° C. for the batteries exemplified in example 2.

FIG. 3 is a discharge curve showing the change in the battery voltage U (in mV) as a function of the discharged capacity C (in mAh) at constant current (7 mA) and at 220° C. for the batteries exemplified in example 3.

FIG. 4 is a discharge curve showing the change in the battery voltage U (in mV) as a function of the time t (in h) at constant current (10 mA) and at 20° C. for the battery exemplified in example 4.

FIG. 5 is a discharge curve showing the change in the battery voltage U (in mV) as a function of the time t (in hours) at constant current (10 mA) and at 70° C. and then at 100° C. for the battery exemplified in example 5.

FIGS. 6 and 7 respectively show the discharge curves showing the change in the battery voltage U (in mV) as a function of the time t (in hours) for the battery not in accordance with the invention and for the battery in accordance with the invention exemplified in example 6.

### DETAILED DESCRIPTION OF PARTICULAR EMBODIMENTS

### Example 1

The purpose of this example is to demonstrate the performance levels of a battery in accordance with the intervention in terms of discharge at a high temperature (165°) in comparison with a battery that is not in accordance with the invention.

The battery in accordance with the invention is a battery with a so-called concentric electrodes structure (format C) and more specifically comprises the following elements:
a positive electrode with a height of 30 mm placed at the centre taking the form of a carbon-containing matrix made up of a web of carbon fibres with a porosity of 92%, a specific surface area of 5 m²/g and a mass per unit surface area of 20 g/m², where the matrix is intended to receive the electrolyte, namely the solvent (which acts as the active material of the electrolyte), which is thionyl chloride and the electrolytic salt (namely, Sr(AlCl₄)₂, 1.5 M from the reaction of SrCl2 and of AlCl₃);
the negative electrode made of calcium arranged concentrically relative to the positive electrode;
between the positive electrode and the negative electrode, an annular separator and a separator in the form of a disk;
a receptacle for the assembly in the form of a jacket, which forms the negative pole of the battery;
a glass-metal bushing welded to the jacket;
a pin positioned in the upper part of the battery, at the glass-metal bushing, where this pin forms the positive pole of the battery, this pin being linked to the positive electrode via a positive connection.

The battery not in accordance with the invention has a similar structure to that of the invention, although only the positive electrode consists of a carbon-containing matrix, composed of carbon-black and a polymer binder of the polytetrafluoroethylene type, said matrix being deposited on a nickel grid.

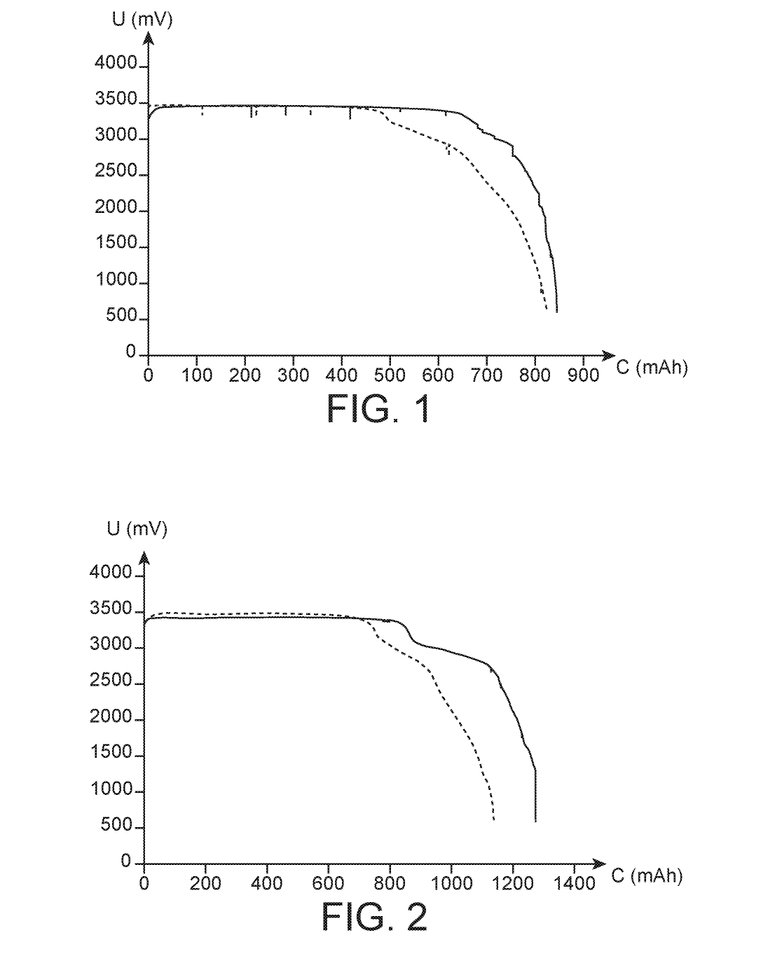

For both these batteries, the discharge curve is determined, that is, the curve showing the change in the battery voltage U (in mV) as a function of the discharged capacity C (in mAh) at constant current (5 mA) and at 165° C. (in FIG. 1, the unbroken line for the battery in accordance with the invention, and the dotted line for the battery not in accordance with the invention, respectively).

There is no plateau voltage difference between the two positive electrodes, which shows that there is no over-voltage resulting from the use of the electrode of the battery in accordance with the invention. The electrical contact is not affected. On the other hand the battery voltage remains high over a greater number of hours in the case of the battery of the invention. The mass of carbon of the electrode of the battery that is not in accordance with the invention is 1.6 g as against 0.042 g for the electrode of the battery of the invention, which corresponds respectively to 0.515 Ah g⁻¹ and 20 Ah g⁻¹.

The capacity per unit mass of the electrode of the batteries of the invention is therefore nearly forty times greater than that of the electrode of the battery not in accordance with the invention.

### Example 2

This example is similar to example 1, although the discharge experiment is performed at 7 mA.

The discharge curve, that is, the curve showing the change in the battery voltage U (in mV) as a function of the discharged capacity C (in mAh) at constant current (7 mA) and at 165° C. (the unbroken line for the battery in accordance with the invention, and the dotted line for the battery not in accordance with the invention, respectively), is shown in FIG. 2.

There is little difference in the plateau voltage between the two positive electrodes, which shows that there is no significant over-voltage resulting from the use of the electrode of the battery in accordance with the invention. The electrical contact is not affected. On the other hand, the battery voltage remains high over a greater number of hours in the case of the electrode of the battery in accordance with the invention. The mass of carbon of the electrode of the battery that is not in accordance with the invention is 1.6 g as against 0.042 g for the electrode of the battery in accordance with the invention, which corresponds respectively to 0.712 Ah g⁻¹ and 30 Ah g⁻¹.

The capacity per unit mass of the electrode of the battery that is in accordance with the invention is therefore nearly forty times greater than that of the electrode of the battery not in accordance with the invention.

### Example 3

This example is similar to that of example 1, although the discharge experiment is performed at 7 mA and at 220° C. and for an electrode height of 20 mm.

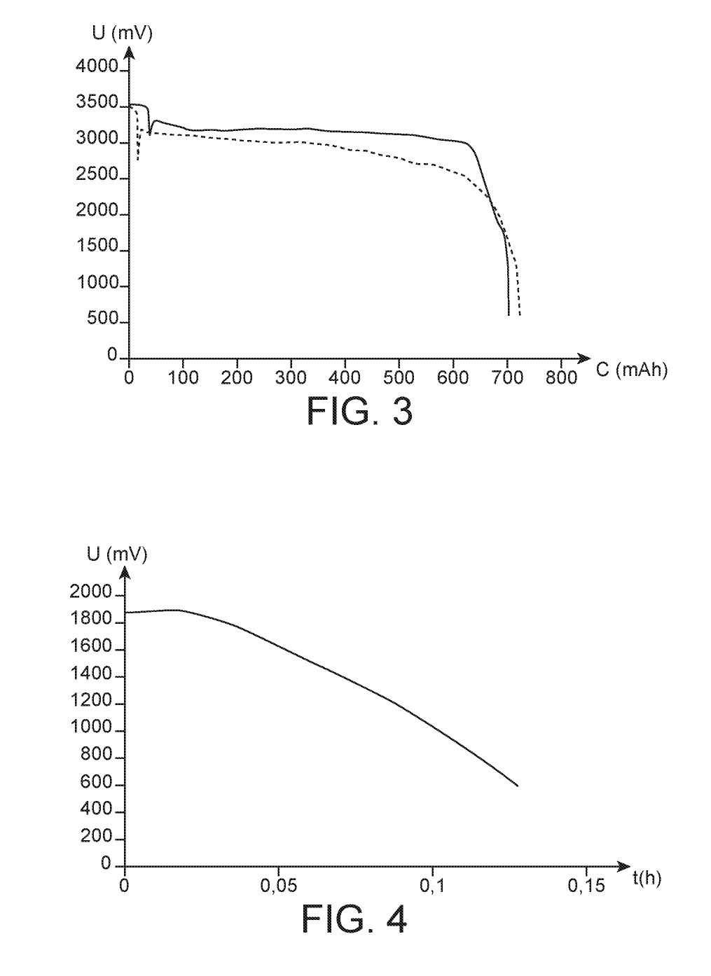

The discharge curve, that is, the curve showing the change in the battery voltage U (in mV) as a function of the discharged capacity C (in mAh) at constant current (7 mA) and at 220° C. (the unbroken line for the battery in accordance with the invention, and the dotted line for the battery not in accordance with the invention, respectively), is shown in FIG. 3.

It emerges from this figure that the plateau voltage is improved by the use of the electrode of the battery that is in accordance with the invention.

### Example 4

This example is similar to that of example 1, although the discharge experiment is performed at 10 mA and at 20° C. only for the battery that is in accordance with the invention.

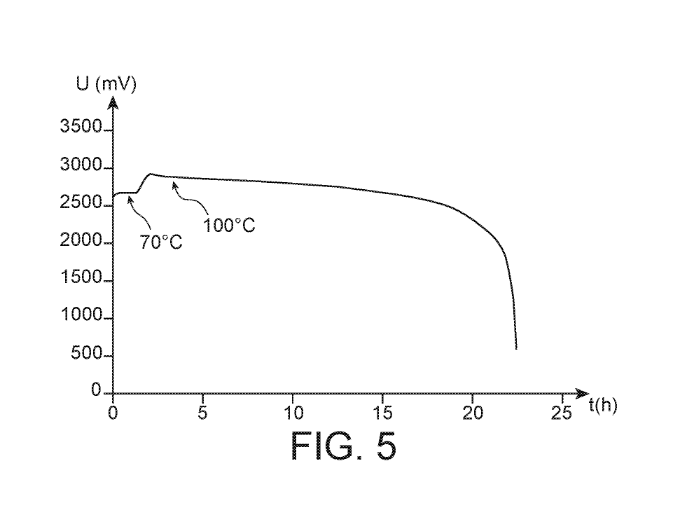

The discharge curve, that is the curve showing the change in the battery voltage U (in mV) as a function of the time t (in hours) at constant current (10 mA) and at 20° C. is shown in FIG. 4.

It emerges from this figure that a delivered voltage greater than 1.5V at ambient temperature immediately appears.

### Example 5

This example is similar to that of example 1, although the discharge experiment is performed at 10 mA at 70° C. then at 100° C. only for the battery that is in accordance with the invention.

The discharge curve, that is the curve showing the change in the battery voltage U (in mV) as a function of the time t (in hours) at constant current (10 mA) at 70° C. then at 100° C. is shown in FIG. 5.

It emerges from this figure that the battery discharges at 10 mA at 70° C. with a voltage greater than 2.5 V. The over-voltage decreases substantially if the temperature increases to 100° C. Since the developed surface area of the electrode is very small, the discharge is short under these temperature conditions.

### Example 6

This example is similar to that of example 1, although the discharge experiment is performed using a pulsed discharge regime at 2 mA (59 secondes) and 100 mA (1 seconde) at 220° C.

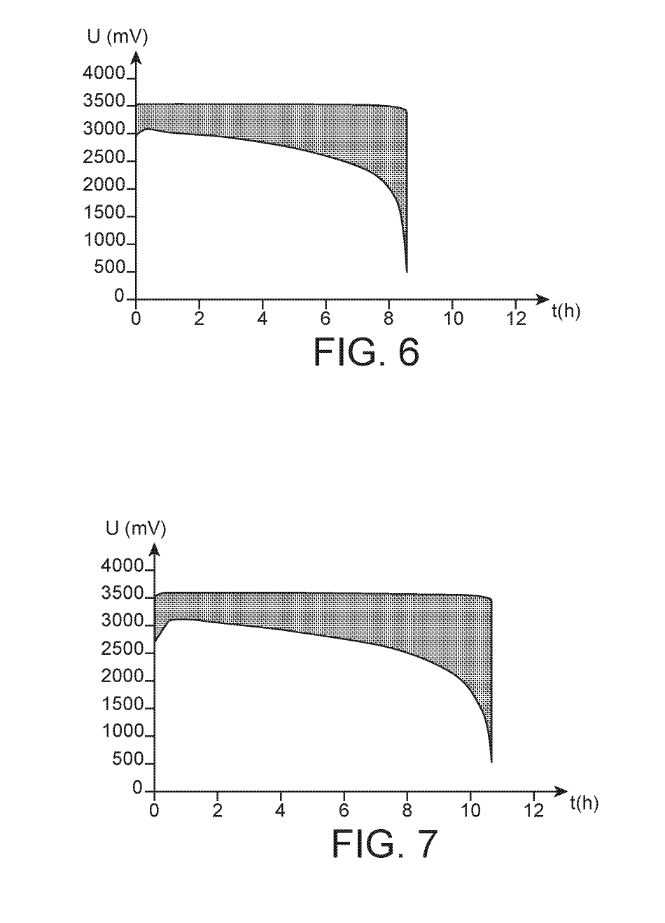

The discharge curves, that is the curves showing the change in the battery voltage U (in mV) as a function of the time t (in hours) are shown in FIG. 6 for the battery that is not in accordance with the invention and in FIG. 7 for the battery that is in accordance with the invention, respectively.

It emerges from these figures that the discharge is longer for the battery that is in accordance with the invention. The voltage is not affected by the use of carbon fibres, even in the case of the pulse at 100 mA.

1. Liquid cathode battery comprising:
an anode made of calcium;
an electrolyte comprising a sulphur-containing and/or phosphorous-containing oxidising solvent and at least one salt;
a cathode comprising, as the active material, a compound which is identical to the above-mentioned oxidising solvent, and which comprises a carbon-containing matrix;
characterised in that the carbon-containing matrix is a self-supporting matrix which comprises interlaced carbon fibres which have a porosity of at least 90% and a specific surface area equal to or less than 5 m²/g.

2. Battery according to claim 1 wherein the carbon-containing matrix is primarily or even exclusively composed of interlaced carbon fibres.

3. Battery according to claim 1, wherein the carbon fibres have a length of less than 20 mm and a diameter of less than 15 μm.

4. Battery according to claim 1, wherein the carbon-containing matrix meets the requirements of one or more of the following characteristics:
a mass per unit surface area less than or equal to 20 g/m2;
when the matrix takes the form of a plate, its thickness is less than 1 mm, preferably less than 0.5 mm;
the carbon-containing matrix is free of polymer binder.

5. Battery according to claim 1, wherein the oxidising solvent is a sulphur-containing solvent, comprising one or more chlorine atoms, a non-chlorine-containing sulphur-containing solvent or a phosphorous-containing and possibly sulphur-containing solvent comprising one or more chlorine atoms.

6. Battery according to claim 5, wherein the sulphur-containing solvent, comprising one or more chlorine atoms, is chosen from thionyl chloride (SOCl₂), sulphuryl chloride (SO₂Cl₂), disulphur dichloride (S₂Cl₂), sulphur dichloride (SCl₂).

7. Battery according to claim 5, wherein the phosphorous-containing and possibly sulphur-containing solvent comprising one or more chlorine atoms is chosen from phosphoryl trichloride (POCl₃), thiophosphoryl trichloride (PSCl₃).

8. Battery according to claim 1, wherein the oxidising solvent is thionyl chloride (SOCl₂).

9. Battery according to claim 1, wherein the salt is the result of the reaction of a Lewis acid with a Lewis base.

10. Battery according to claim 1, wherein the electrolyte comprises one or more additives chosen from hydrofluoric acid HF, SO₂, salts such as GaCl₃, BiCl₃, BCl₃, GaCl₃, InCl₃, VCl₃, SiCl₄, NbCl₅, TaCl₅, PCl₅ and WCl₆.
